(19) United States
(12) Patent Application Publication
(10) Pub. No.: US 2024/0383135 A1
(43) Pub. Date: Nov. 21, 2024

(54) COLLABORATIVE ROBOT SYSTEM

(71) Applicant: NACHI-FUJIKOSHI CORP., Tokyo (JP)

(72) Inventor: Tatsurou FUJISAWA, Toyama (JP)

(73) Assignee: NACHI-FUJIKOSHI CORP., Tokyo (JP)

(21) Appl. No.: 18/660,248

(22) Filed: May 10, 2024

(30) Foreign Application Priority Data
May 15, 2023 (JP) 2023-80329

(51) Int. Cl. B25J 9/16; B25J 13/08

(52) U.S. Cl. CPC B25J 9/1633; B25J 9/1653; B25J 9/1676; B25J 13/085; B25J 13/088

(57) ABSTRACT

A collaborative robot system includes: an each-axis position calculator that calculates a position of each of axes in order from one of the axes closest to an installation surface of a multi-axis robot; and an external force estimation device. The external force estimation device decomposes torque at each of the axes detected by a torque sensor into axial rotation components in three dimensions, based on the position of each of the axes calculated by the each-axis position calculator and, by creating, for each of the axial rotation components, equations in which the position and the magnitude of the external force for each of the axes are assumed to be unknowns and solving the equations as simultaneous equations, estimates the position and the magnitude of the external force applied to the multi-axis robot.

This application is based upon and claims the benefit of priority from the prior Japanese Patent Application No. 2023-080329, filed on May 15, 2023, the entire contents of which are incorporated herein by reference.

### FIELD OF THE INVENTION

The present invention relates to a collaborative robot system having a safety function.

### DESCRIPTION OF THE RELATED ART

Safety measures are required for industrial robots that share a work area with humans, so-called collaborative robots. As a standard of safety required for the collaborative robots, the technical specification ISO/TS 15066 referred to from ISO 10218-1 defines safe “force” when coming into contact with each part of the human body (at the time of collision).

As the collaborative robot, a multi-axis robot having a plurality of arms is generally used, and a torque sensor for detecting torque is provided on each axis of the arms, for example. Note that the torque is a value obtained by multiplying the length from the rotation center by “force”. For this reason, the collaborative robot provided with the torque sensor is incapable of distinguishing whether a strong force has been applied at a position close to the rotation center or a weak force has been applied at a position far from the rotation center even with the same torque.

Patent Document 1 (JP 2022-15850 A) discloses a robot system in which at least one joint (axis) of a robot is provided with a torque sensor that detects torque around a rotation axis. In this robot system, an external force applied to the robot is detected by detecting force components in each of axis directions of an X-axis, a Y-axis, and a Z-axis and a torque component acting around the rotation axis with the torque sensor. In addition, it is disclosed that a force sensor may be used instead of the torque sensor (for detecting the external force applied to the robot).

### BRIEF SUMMARY OF THE INVENTION

In order to solve the above-problems, a representative configuration of a collaborative robot system according to the present invention includes: a multi-axis robot having a plurality of arms; a position detector provided on each of axes of the multi-axis robot; a torque sensor that is provided on each of the axes of the multi-axis robot and detects torque at each of the axes; and a robot controller that controls an operation of the multi-axis robot, in which the robot controller includes: a link parameter storage that stores a link parameter including a length of each of the arms; an each-axis position calculator that calculates a position of each of the axes in order from one of the axes closest to an installation surface of the multi-axis robot, using positions of the axes detected by the position detectors and the link parameter read from the link parameter storage; and an external force estimation device that estimates a position and a magnitude of an external force applied to the multi-axis robot, and the external force estimation device decomposes the torque at each of the axes detected by the torque sensor into axial rotation components in three dimensions, based on the position of each of the axes calculated by the each-axis position calculator; and by creating, for each of the axial rotation components, equations in which the position and the magnitude of the external force for each of the axes are assumed to be unknowns and solving these equations as simultaneous equations, estimates the position and the magnitude of the external force.

### BRIEF DESCRIPTION OF THE DRAWINGS

FIG. 1 is a diagram schematically illustrating an overall configuration of a collaborative robot system according to an embodiment of the present invention;

FIG. 2 is a functional block diagram of the collaborative robot system in FIG. 1;

FIG. 3 is a flowchart illustrating an operation of the collaborative robot system in FIG. 1;

FIG. 4 is a diagram explaining a method of estimating the position and magnitude of an external force by the collaborative robot system in FIG. 1;

FIG. 5A is a diagram illustrating a specific example of estimating the position and magnitude of an external force from torque between axes in the same rotation direction by the collaborative robot system in FIG. 1;

FIG. 5B is a specific example of a case where the position of the external force is different with reference to FIG. 5A;

FIG. 6A shows a case where the J4 axis is added to the cooperative robot system of FIG. 1;

FIG. 6B shows a case where the J7 axis is added to the collaborative robot system of FIG. 6A;

FIG. 7 is a flowchart illustrating exception processing in FIG. 3; and

FIG. 8 is a functional block diagram of a collaborative robot system according to another embodiment of the present invention.

### DETAILED DESCRIPTION

Hereinafter, preferred embodiments of the present invention will be described in detail with reference to the accompanying drawings. Dimensions, materials, other specific numerical values, and the like indicated in such embodiments are merely examples for facilitating understanding of the invention and do not limit the present invention unless otherwise noted. Note that, in the present description and the drawings, elements having substantially the same function or configuration will be denoted by the same reference signs, and redundant description will be omitted. Additionally, elements not directly related to the present invention will not be illustrated.

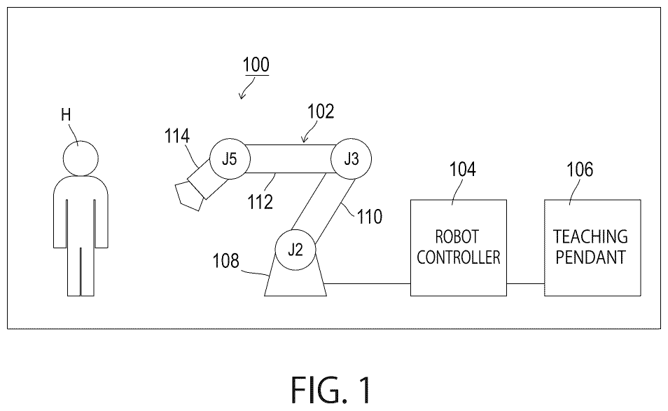

FIG. 1 is a diagram schematically illustrating an overall configuration of a collaborative robot system 100 according to an embodiment of the present invention. The collaborative robot system 100 is an industrial robot system in which a worker H and a robot 102 share a work area and includes the robot 102, a robot controller 104, and a teaching pendant 106. The teaching pendant 106 is a device connected to the robot controller 104, on which the robot 102 is manipulated and various types of information is displayed.

The robot 102 is a multi-axis robot whose operation is controlled by the robot controller 104 and includes, for example, a turning frame 108, a first arm 110, a second arm 112, and an end effector 114. Note that the end effector 114 is, for example, a hand or a gripper that grips an object intended to be hold.

The first arm 110 of the robot 102 is rotatably coupled to the turning frame 108 via a J2 axis. The second arm 112 is rotatably coupled to the first arm 110 via a J3 axis. The end effector 114 is rotatably coupled to the second arm 112 via a J5 axis.

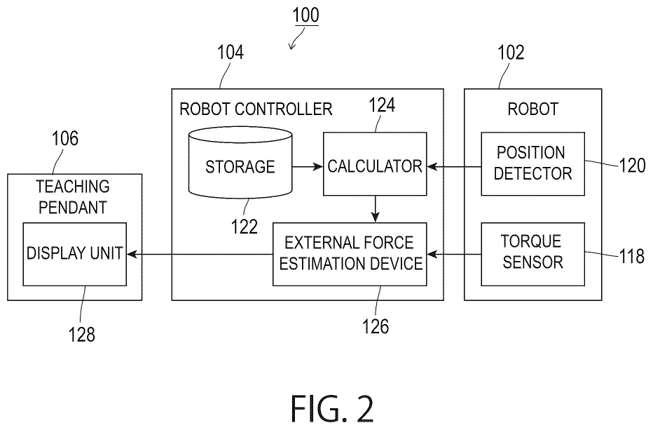

A torque sensor 118 (see FIG. 2) that detects torque is provided on each axis of the robot 102, that is, the J2 axis, the J3 axis, and the J5 axis. Torque is a value obtained by multiplying the length from the rotation center by “force”. For this reason, when the worker H comes into contact with the robot 102 (at the time of collision), as described above, even if the torque detected by the torque sensor 118 is the same, it is difficult to distinguish whether the worker H has been subjected to a strong force at a position closer to the rotation center or a weak force at a position far from the rotation center.

Thus, the collaborative robot system 100 according to the present embodiment employs a configuration adapted to improve the safety of the worker H by estimating a collision position and a magnitude of an external force applied to the robot 102.

FIG. 2 is a functional block diagram of the collaborative robot system 100 in FIG. 1. The robot 102 includes the torque sensor 118 and a position detector 120. The torque sensor 118 detects torque at each axis. The position detector 120 is an encoder and detects the current position, using a rotation angle of each axis of the robot 102. Note that the position detector 120 is provided on each axis of the robot 102.

The robot controller 104 includes a link parameter storage (storage 122), an each-axis position calculator 124, and an external force estimation device 126. The storage 122 stores link parameters that are design parameters for a length and a positional relationship of each arm.

The each-axis position calculator 124 calculates a position of each axis. Specifically, the each-axis position calculator 124 calculates a position of each axis, using the position of the axis detected by the position detector 120 and the link parameters read from the storage 122 in order from an axis closest to an installation surface of the robot 102 that is a multi-axis robot (that is, an axis on a closest side of the turning frame 108). Note that the position of each axis calculated by the each-axis position calculator 124 also includes a posture (direction) of each axis.

The external force estimation device 126 acquires torque at each axis detected by the torque sensor 118 and the position of each axis calculated by the each-axis position calculator 124 and, based on these acquired torque and position, estimates a position and a magnitude of an external force applied to the robot 102 when the worker H comes into contact with the robot 102 (to be described later). In addition, the teaching pendant 106 includes a display unit 120. The display unit 120 displays the position and magnitude of the external force estimated by the external force estimation device 126.

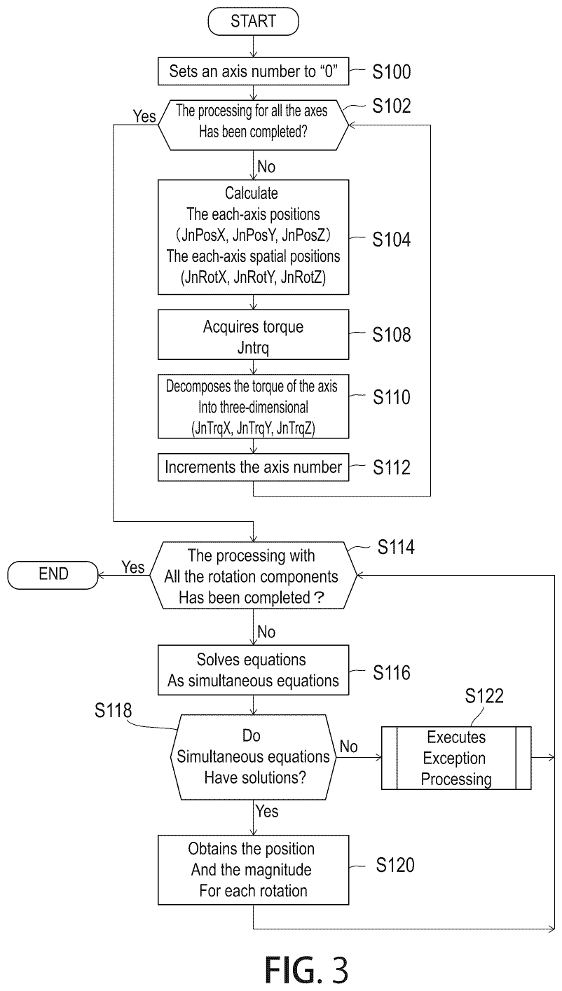

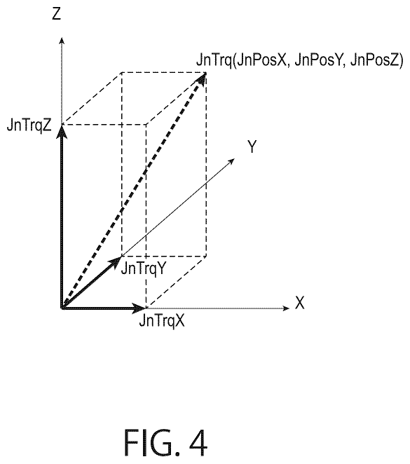

FIG. 3 is a flowchart illustrating an operation of the collaborative robot system 100 in FIG. 1. FIG. 4 is a diagram explaining a method of estimating the position and magnitude of the external force by the collaborative robot system 100 in FIG. 1.

In the collaborative robot system 100, first, the robot controller 104 sets an axis number to “0” (step S100), determines whether or not the processing for all the axes has been completed, depending on whether or not the axis number is smaller than the total number of axes of the robot 102 (step S102), and in a case where the processing has not been completed (a case where the axis number is smaller than the total number of axes of the robot 102) (No), performs the processing in step S104.

In step S104, the each-axis position calculator 124 calculates X-, Y-, and Z-axis spatial positions (JnPosX, JnPosY, JnPosZ) of an axis and the X-, Y-, and Z-axial rotation components (JnRotX, JnRotY, JnRotZ) of the axis, using the current position of the axis detected by the position detector 120 and the link parameters read from the storage 122. In this manner, the each-axis position calculator 124 calculates the position including the posture (direction) of the axis.

Subsequently, the external force estimation device 126 acquires torque (JnTrq) of the axis detected by the torque sensor 118 (step S108). Furthermore, as illustrated in FIG. 4, the external force estimation device 126 decomposes the torque (JnTrq) of the axis into three-dimensional axial rotation components, based on an XYZ spatial position (JnPosX, JnPosY, JnPosZ) that is the position of that axis calculated by the each-axis position calculator 124, and calculates torque components (JnTrqX, JnTrqY, JnTraZ) along the X axis, the Y axis, and the Z axis (step S110). Note that the axial rotation includes X-axial rotation (roll), Y-axial rotation (pitch), and Z-axial rotation (yaw).

After step S110, the robot controller 104 increments the axis number (step S112), returns to the processing in step S102 to determine again whether or not the processing for all the axes has been completed, and performs the processing in step S114 when the processing has been completed (Yes).

In step S114, the robot controller 104 determines whether or not the processing with all the rotation components has been completed, and in a case where the processing has not been completed (No), the processing by the external force estimation device 126 is performed thereafter.

First, the external force estimation device 126 formulates equations in which the position and magnitude of the external force are assumed to be unknowns, for each of the three-dimensional axial rotation components (JnTrqX, JnTrqY, JnTrqZ) of the torque (JnTrq) at each axis of the robot calculated in step S108, and solves these equations as simultaneous equations (step S116).

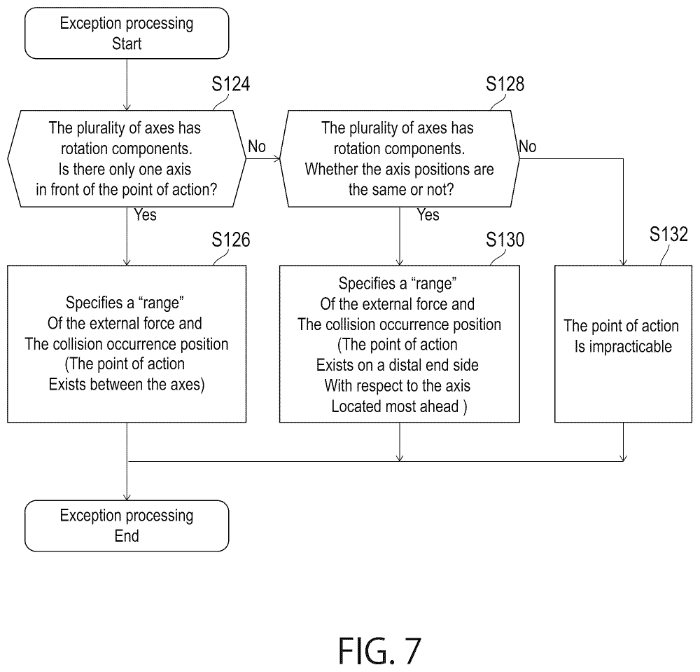

Next, the external force estimation device 126 determines whether or not the simultaneous equations have a solution (step S118) and, in a case where the simultaneous equations have a solution (Yes), obtains the position (collision occurrence position) and the magnitude of the external force applied to the robot 102 for each rotation (step S120). On the other hand, in a case where the simultaneous equations have no solution in step S118 (No), the external force estimation device 126 executes exception processing (see FIG. 7) in step S122 (to be described later).

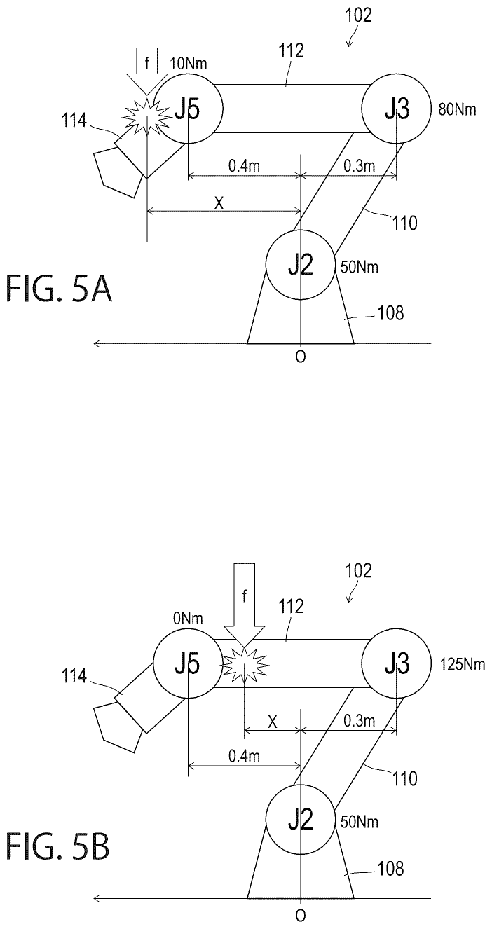

Here, the processing in steps S116 and S120 by the external force estimation device 126 will be specifically described. FIGS. 5A and 5B are diagrams illustrating specific examples of estimating the position and magnitude of an external force from torque between axes in the same rotation direction by the collaborative robot system 100 in FIG. 1. In the drawings, a distance x from an origin O to the collision position of the external force and a magnitude f of the external force are set as unknowns.

In the robot 102 illustrated in FIG. 5A, the torque at the J2 axis, the J3 axis, and the J5 axis detected by the torque sensor 118 has 50 Nm, 80 Nm, and 10 Nm, respectively. In addition, the distance between the axial centers of the J2 axis and the J3 axis and the distance between the axial centers of the J2 axis and the J5 axis are 0.3 m and 0.4 m, respectively. Note that the distance between the axial centers can be found from the link parameters and the axial angle.

From these conditions, the following three equations in which the position (the distance x from the origin O to the collision position of the external force) and the magnitude f of the external force are assumed to be unknowns can be formulated for each axis of the robot.

$$J 2 : xf = 50 \\ J 3 : ( x + 0.3 ) f = 80 \\ J 5 : ( x - 0.4 ) f = 10$$

By solving these three equations as simultaneous equations, values of f=100 N and x=0.5 m can be obtained. Note that, since x=0.5 m is found, as illustrated in FIG. 5A, it can be seen that an external force having a magnitude of 100 N has been applied to the robot 102 at the end effector 114 positioned 0.1 m ahead of the J5 axis.

In the robot 102 illustrated in FIG. 5B, the torque at the J2 axis, the J3 axis, and the J5 axis detected by the torque sensor 118 has 50 Nm, 125 Nm, and 0 Nm, respectively. Note that, since the torque at the J5 axis has 0 Nm, there is no load ahead of the J5 axis. In addition, the distance between the axial centers of the J2 axis and the J3 axis and the distance between the axial centers of the J2 axis and the J5 axis are 0.3 m and 0.4 m, respectively.

From these conditions, the following two equations in which the position (the distance x from the origin O to the collision position of the external force) and the magnitude f of the external force are assumed to be unknowns can be created for each axis of the robot.

$$J 2 : xf = 50 \\ J 3 : ( x + 0.3 ) f = 125$$

By solving these two equations as simultaneous equations, values of f=250 N and x=0.2 m can be obtained. Note that, since x=0.2 m is found, as illustrated in FIG. 5B, it can be seen that an external force having a magnitude of 250 N has been applied to the robot 102 at the second arm 112 positioned 0.5 m ahead of the J3 axis.

In this manner, the external force estimation device 126 can estimate the position and magnitude of the external force applied to the robot 102 by the processing in steps S116 and S120. After step S120, the robot controller 104 returns to the processing in step S114 to determine again whether or not the processing with all the rotation components has been completed and ends the operation when the processing has been completed (Yes).

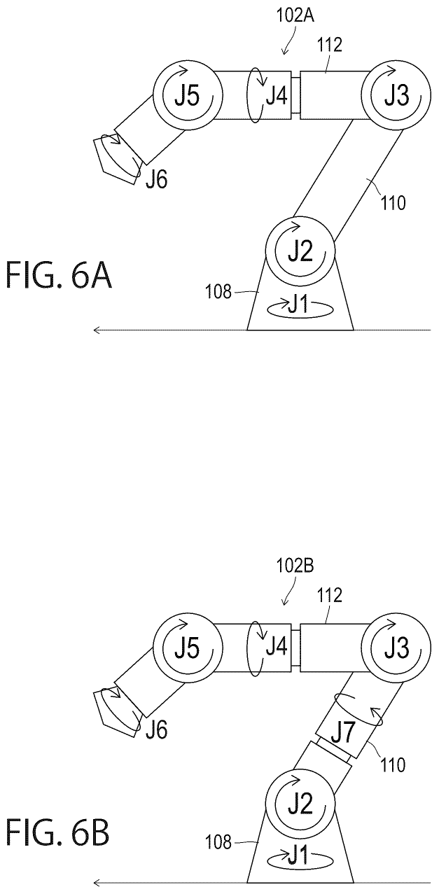

FIGS. 6A and 6B are diagrams illustrating cases where other robots 102A and 102B are applied to the collaborative robot system 100 in FIG. 1.

The robot 102A illustrated in FIG. 6A is a six-axis robot in which a J1 axis rotates about the Z axis (yaw), and J2 and J3 axes rotate about the Y axis (pitch). Furthermore, in the robot 102A, whether the axial rotation of a J4 axis, a J5 axis, or a J6 axis has yaw or pitch depends on a previous axis.

Accordingly, in a case where the six-axis robot (robot 102A) is applied to the collaborative robot system 100, if the axial rotations of the J4 axis, the J5 axis, and the J6 axis are designated by the previous axes of the J4 axis, the J5 axis, and the J6 axis of the robot 102A, the position and magnitude of the external force applied to the robot 102A can be estimated except the exception processing (see FIG. 7) to be described later.

The robot 102B illustrated in FIG. 6B is a seven-axis robot in which a J1 axis rotates about the Z axis (yaw), and a J2 axis rotates about the Y axis (pitch). Furthermore, in the robot 102B, whether the axial rotation of a J7 axis, a J3 axis, a J4 axis, a J5 axis, or a J6 axis has yaw or pitch depends on a previous axis.

Accordingly, in a case where the seven-axis robot (robot 102B) is applied to the collaborative robot system 100, if the axial rotations of the J7 axis, the J3 axis, the J4 axis, the J5 axis, and the J6 axis are designated by the previous axes of the J7 axis, the J3 axis, the J4 axis, the J5 axis, and the J6 axis of the robot 102B, the position and magnitude of the external force applied to the robot 102B can be estimated except the exception processing (see FIG. 7) to be described later.

FIG. 7 is a flowchart illustrating the exception processing in FIG. 3. The external force estimation device 126 executes the exception processing in a case where the simultaneous equations have no solution in step S116 or in a case where the simultaneous equations cannot be formulated.

In the exception processing, the external force estimation device 126 determines whether or not the point of action (collision occurrence position) has only one previous axis while the plurality of axes has rotation components as illustrated in FIG. 7 (step S124). That is, this is a case where torque is generated at only one axis, and simultaneous equations are not creatable because only one equation can be formulated at this time. When there is only one previous axis in step S124 (Yes), the external force estimation device 126 specifies a “range” of the external force and the collision occurrence position (step S126).

As an example of step S126, when the torque detected at the J2 axis and the J3 axis satisfies J2>>0 Nm and J3≈0 Nm, it can be seen that the point of action exists on the first arm 110 between the J2 axis and the J3 axis. In other words, the range of the point of action can be specified.

In a case where there is not only one previous axis in step S124 (No), the external force estimation device 126 determines whether or not the plurality of axes has the same position while the plurality of axes has rotation components (step S128). That is, even if torque is generated at the plurality of axes, when the positions of the axes are the same, the positions will have the same numerical value although the torque has different numerical values, and thus the simultaneous equations will no longer have a solution.

Thus, when the axes have the same position in step S128 (Yes), the external force estimation device 126 specifies the “range” of the external force and the collision occurrence position (step S130). In step S130, at least it can be seen that the point of action exists on a distal end side with respect to the axis located most ahead (the axis farthest from the J2 axis) among axes at which torque is generated.

On the other hand, in a case where the plurality of axes has no force of the same direction component while the plurality of axes has rotation components in step S128 (No), only one equation can be formulated for each direction component. Examples of this case include a case where torque is detected only at the J1 axis for turning the turning frame 108. In this case, estimation of the point of action is impracticable (step S132). The external force estimation device 126 ends the exception processing in this manner, performs the processing in step S114 again as illustrated in FIG. 3, and ends the operation.

Therefore, according to the collaborative robot system 100, the position and magnitude of the external force applied to the robot 102 can be estimated except the exception processing, and the safety can be improved. Even in the exception processing, although estimation of the position and magnitude of the external force is not reached, at least the range of the point of action can be specified.

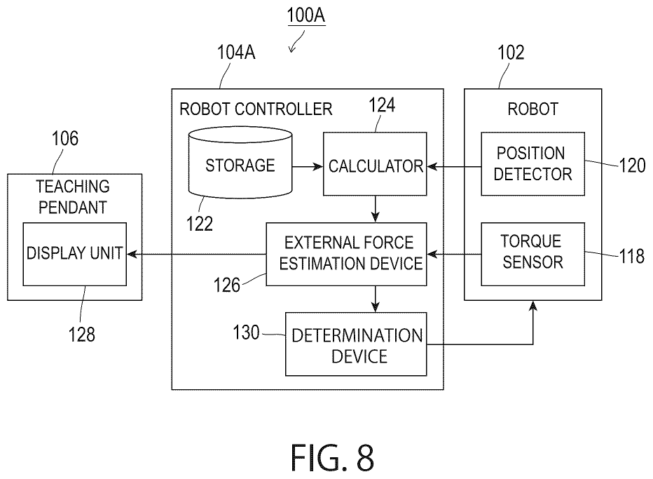

FIG. 8 is a functional block diagram of a collaborative robot system 100A according to another embodiment of the present invention. The collaborative robot system 100A includes a robot 102 and a robot controller 104A. The robot controller 104A is different from the above-described robot controller 104 in including a collision determination device 130. The position and magnitude of the external force applied to the robot 102 are sent to the collision determination device 130 from the external force estimation device 126.

The collision determination device 130 of the robot controller 104A compares the magnitude of the external force applied to the robot 102 with a reference value and transmits a stop command to the robot 102 in a case where the magnitude of the external force exceeds the reference value. This can further improve the safety.

While the preferred embodiments of the present invention have been described above with reference to the accompanying drawings, it goes without saying that the present invention is not limited to such examples. It is apparent that those skilled in the art can conceive of various altered examples or modified examples within the scope described in the claims, and it is construed that these examples naturally fall within the technical range of the present invention. For the purposes of the present disclosure, the term ‘a’ or ‘an’ entity refers to one or more of that entity. As such, the terms ‘a’ or ‘an’, ‘one or more’ and ‘at least one’ can be used interchangeably herein.

The present invention is applicable to a collaborative robot system having a safety function.

What is claimed is:

1. A collaborative robot system comprising:
a multi-axis robot having a plurality of arms;
a position detector provided on each of axes of the multi-axis robot;
a torque sensor that is provided on each of the axes of the multi-axis robot and detects torque at each of the axes; and
a robot controller that controls an operation of the multi-axis robot, wherein the robot controller includes:
a link parameter storage that stores a link parameter including a length of each of the arms;
an each-axis position calculator that calculates a position of each of the axes in order from one of the axes closest to an installation surface of the multi-axis robot, using positions of the axes detected by the position detectors and the link parameter read from the link parameter storage; and
an external force estimation device that estimates a position and a magnitude of an external force applied to the multi-axis robot, and
the external force estimation device:
decomposes the torque at each of the axes detected by the torque sensor into axial rotation components in three dimensions, based on the position of each of the axes calculated by the each-axis position calculator; and
by creating, for each of the axial rotation components, equations in which the position and the magnitude of the external force for each of the axes are assumed to be unknowns and solving these equations as simultaneous equations, estimates the position and the magnitude of the external force.

2. The collaborative robot system according to claim 1, wherein the robot controller includes a collision determination device that transmits a stop command to the multi-axis robot in a case where the external force exceeds a reference value.
